(19) United States
(12) Patent Application Publication
(10) Pub. No.: US 2025/0176764 A1
(43) Pub. Date: Jun. 5, 2025

(54) Elevated Cutting Board Assembly

(71) Applicant: Nate Schanfein, Fontana, CA (US)

(72) Inventor: Nate Schanfein, Fontana, CA (US)

(21) Appl. No.: 18/963,959

(22) Filed: Nov. 29, 2024

Related U.S. Application Data
(60) Provisional application No. 63/604,813, filed on Nov. 30, 2023.

(51) Int. Cl. A47J 47/00

(52) U.S. Cl. CPC A47J 47/005

(57) ABSTRACT

A cutting board assembly that allows its user to adjust the distance of the cutting board above the surface of a kitchen countertop, thereby eliminating the need for the user to stoop while using the cutting board. The cutting board assembly comprises a cutting board suitable for food preparation, along with a set of pieces that may be stacked together to form pillars that support the cutting board above the surface of a kitchen countertop. The height of the cutting board may vary depending on the number of stacking pieces used. The stacking pieces may be releasably connected by any number of means, such as friction fit, twist and lock, or magnetic attraction. The bottom of the base pieces may further include a non-skid surface to reduce movement between the base pieces and the kitchen countertop. Likewise, the top of the top pieces may further include a non-skid surface to reduce movement between the top piece and the cutting board.

### CROSS-REFERENCE TO RELATED APPLICATIONS

This application claims priority from U.S. Provisional Patent Application No. 63/604,813, filed on Nov. 30, 2023, and titled “Elevated Cutting Board Assembly.” The entire disclosure of the prior application is considered to be part of the disclosure of the accompanying application and is hereby incorporated by reference.

### BACKGROUND OF THE INVENTION

### 1. Field of the Invention

The present invention relates to kitchen cooking devices and, more particularly, to an improved cutting board whose elevation may be incrementally adjusted.

### 2. Related Art

Food preparation often requires cutting or slicing food products before cooking or serving them. These food products may be animal meats, nuts, fruits, and vegetables. Cutting boards are often used for these types of cutting and slicing, among other reasons, to protect the countertop from being marred, scratched, or cut by the cutting utensil and to protect the cutting utensil from becoming dull as many times countertops are particularly hard.

Conventional cutting boards are typically a planar substrate that rests on a kitchen countertop. The cutting board has a surface where food products are placed to be cut using a cutting utensil such as a knife. These conventional cutting boards provide a surface to cut food products without damaging the table or dulling the cutting utensil. The height of the cutting board is limited to the height of the countertop upon which it rests. Most countertops have a set height to accommodate the broadest range of users. This means that taller users must bend their backs while preparing food, and eventually, this constant bending creates back pain that may require medical treatment. Attempts to solve this problem have focused on adding legs to conventional cutting boards. These legs raise the height of the cutting surface in an attempt to reduce the likelihood of back trauma.

U.S. Pat. No. 11,638,501 to Brooks Ruhman et al. discloses a cutting board apparatus having four legs wherein the legs may be screwed into the base of the cutting board. The four legs have threaded feet that may be screwed in one direction to retract the foot into the leg, thereby decreasing the overall length of the leg, and when screwed in the opposite direction, to extend the foot out of the leg and thereby increasing the overall length of the leg. The legs are stored within multiple cavities found underneath the cutting board. When storing the legs, the feet must be retracted within the leg, thereby losing its previous position. This requires the user to readjust each leg to its proper length each time the cutting board is used. If each leg is not correctly adjusted, the cutting board will not be flat, resulting in food juices pouring off from the cutting board.

U.S. Pat. No. 7,849,789 to Michael Whelan discloses a cutting board with two means of adjusting its height. The first means comprises legs attached to the corners of the cutting board via a hinge. Because of the hinge, the legs may be extended into a deployed configuration or retracted into a storage configuration. Each leg has a foot portion that slides along the axis of its respective leg. The leg is constructed with an opening, and multiple matching openings exist along the foot portion. To adjust the height of the cutting board, the opening in the leg is aligned with the desired opening in the foot, and a peg is inserted into the openings to prevent further movement of the foot portion within the leg. The second means discloses a cutting board with an adjustable frame and a ratchet mechanism. The adjustable frame includes a base. Attached to the base are legs arranged in a “scissor” configuration. The ratchet mechanism is used to retain the scissor legs at various angles to position the cutting board at a predetermined height. However, such a design is bulky and adds weight to the cutting board, and the many parts increase the chance of breakage, resulting in a useless cutting board.

What is needed is a cutting board apparatus that allows the cutting board to be used at countertop height or mounted on legs so that it may be raised to an appropriate height and eliminate the need for the user to stoop while using it.

### BRIEF SUMMARY OF THE INVENTION

The present invention comprises an assembly designed to work together to adjust the height of a cutting board. The adjustment may be accomplished by stacking pieces, where each stack forms a leg or what is referred to as a pillar in this disclosure.

It is an objective of the present invention that the cutting board may be positioned as traditional cutting boards are positioned. That is flat upon a kitchen countertop.

A further objective of the present invention is that the cutting board may be raised above the countertop's surface. This provides two advantages. First, the user of the cutting board will not be required to bend when using it, and second, the space underneath the cutting board may be used for other purposes, such as storing knives or food products.

A further objective of the present invention is that the cutting board may be raised from the countertop's surface by stacking pieces atop each other.

A further objective of the present invention is that the stacking pieces may be used with other cutting boards. The pieces are not associated with a particular cutting board and may be used with various existing cutting boards.

A further objective of the present invention is that the number of stacking pieces may vary depending on the desired height of the cutting board.

### BRIEF DESCRIPTION OF DRAWINGS

The present invention will become more fully understood from the detailed description and accompanying drawings. Other systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims. Component parts shown in the drawings are not necessarily to scale and may be exaggerated to better illustrate the important features of the invention, Dimensions disclosed or shown are exemplary only. In the drawings, like reference numerals may designate like parts throughout the different views, wherein:

FIG. 1 shows an isometric view of the first embodiment of the elevated cutting board assembly of the present disclosure wherein the cutting board is at a first height.

FIG. 2 shows an isometric view of the second embodiment of the elevated cutting board assembly of the present disclosure wherein the cutting board is at a second height.

FIG. 3A shows an isometric view of the flat base piece of the elevated cutting board assembly of the present disclosure.

FIG. 3B shows an isometric view of the edge base piece of the elevated cutting board assembly of the present disclosure.

FIG. 3C shows an isometric view of the stacking piece of the elevated cutting board assembly of the present disclosure.

FIG. 3D shows an isometric view of the top piece of the elevated cutting board assembly of the present disclosure.

FIG. 3E shows an isometric view of the corner cover of the elevated cutting board assembly of the present disclosure.

FIG. 4 shows an isometric view of the initial step in assembling the elevated cutting board assembly of the present disclosure.

FIG. 5 shows an isometric view of the first intermediate step in assembling the elevated cutting board assembly of the present disclosure.

FIG. 6 shows an isometric view of a second intermediate step in assembling the elevated cutting board assembly of the present disclosure.

FIG. 7 shows an isometric view of the elevated cutting board assembly of the present disclosure.

### DEFINITIONS

Cutting board—A cutting board is a durable planar substrate on which to place material for cutting. It is normally fabricated from wood or plastic and comes in various widths and sizes. The most common type of cutting board is the kitchen cutting board, commonly used in preparing food. Other types of cutting boards exist for cutting raw materials, such as leather or plastic.

Non-Skid Surface—A non-skid surface is a surface of an object that is comprised of a material that increases the coefficient of friction between the object and another surface the object comes into contact with to reduce the probability of the object moving about the other surface.

### DETAILED DESCRIPTION OF THE INVENTION

It will be readily understood that the components of the embodiments, as generally described herein and illustrated in the figures, could be arranged and designed in a wide variety of different configurations. Thus, the following more detailed description of various embodiments, as represented in the figures, is not intended to limit the scope of the present disclosure but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. Therefore, the scope of the present solution is indicated by the appended claims rather than by this detailed description. All changes that come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution, Thus, discussions of the features and advantages and similar language throughout the specification may, but do not necessarily, refer to the same embodiment.

Furthermore, the described features, advantages, and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

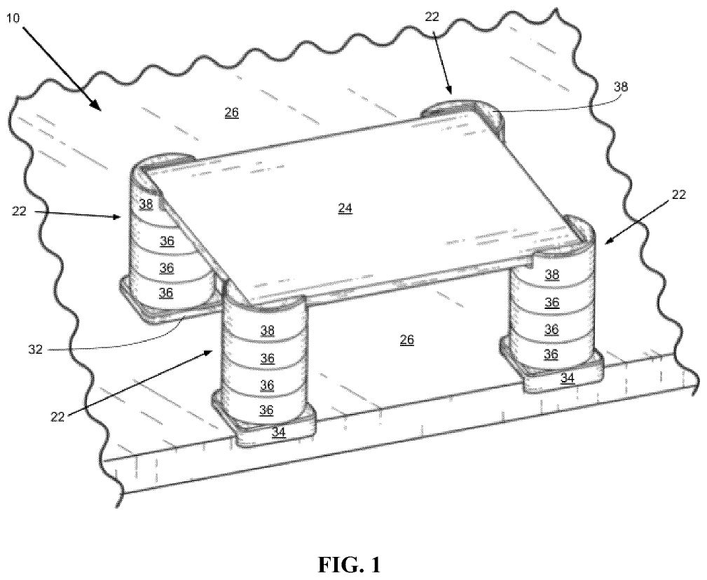

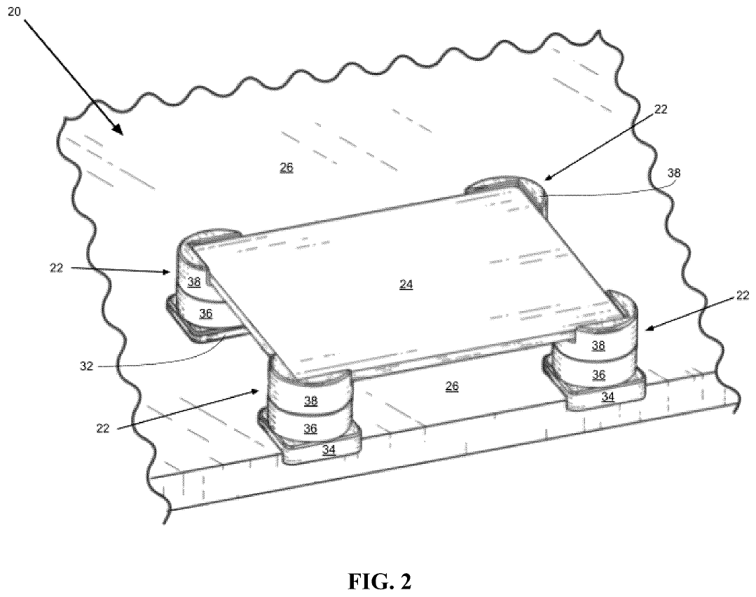

At this time, the reader is referred to FIG. 1, which shows an isometric view of the first embodiment of the elevated cutting board assembly of the present disclosure wherein the cutting board is at a first height. Here, first embodiment 10 has been assembled at the edge of counter surface 26. Counter surface 26 may be a kitchen countertop, a table, or any other flat surface where first embodiment 10 is to be deployed. Moreover, while FIG. 1 shows first embodiment 10 along the edge of counter surface 26, it is not necessary to deploy first embodiment 10 proximate to the edge of counter surface 26, First embodiment 10 may just as easily be deployed away from the edge of counter surface 26. In FIG. 1, first embodiment 10 may be generally described as having four pillar 22 whereon cutting board 24 is supported. Each pillar 22 supports one of the corners of cutting board 24, thereby providing a stable surface on which to place cutting board 24. Each pillar 22 in FIG. 1 is assembled generally similar to one another except for the base piece. When first embodiment 10 is to be deployed proximate to the edge of counter surface 26, edge base piece 34 may be used. Using edge base piece 34 further prevents pillar 22 from moving from its intended location. If first embodiment 10 is not deployed proximate to the edge of counter surface 26, then each pillar 22 may use flat base piece 32. Both flat base piece 32 and edge base piece 34 may have a non-skid surface that comes into contact with counter surface 26 so as to reduce the likelihood of pillar 22 moving about counter surface 26. Above flat base piece 32 or edge base piece 34, as shown in FIG. 1, are three stacking piece 36. None, or one or more, stacking piece 36 may be added to flat base piece 32 or edge base piece 34 as necessary to provide the user with a comfortable cutting experience. FIG. 1 shows first embodiment 10 where three stacking piece 36 has been mounted above each flat base piece 32 or edge base piece 34. FIG. 2 shows second embodiment 20 where one stacking piece 36 have been mounted above each flat base piece 32 or edge base piece 34. A variety of means may be used to releasably mount stacking piece 36 above each flat base piece 32 or edge base piece 34 or onto another stacking piece 36 that are known to one skilled in the art. Shown in the many figures of this disclosure is a friction fit, but other means of coupling, such as twist and lock or magnetic attraction, may be used to releasably join the pieces that makeup pillar 22. The final piece used in assembling pillar 22 is top piece 38. The base of top piece 38 is designed to fit on top of stacking piece 36 and the top of top piece 38 has recess 52 which is configured to receive a corner of cutting board 24, Optionally, if the user does not wish to have cutting board 24 supported at its corners, corner cover 40 may be fitted onto recess 52. A variety of means may be used to releasably secure corner cover 40 to top piece 38 that are known to one skilled in the art. Shown in the many figures of this disclosure is a friction fit, but other means of coupling, such as magnetic attraction, may be used to releasably join corner cover 40 to top piece 38. The upper surface of corner cover 40 may be a non-skid surface to discourage the movement of cutting board 24 along the surface of corner cover 40.

There are a number of advantages to having cutting board 24 elevated above counter surface 26. A first advantage is that cutting board 24 is at a height to provide a more comfortable cutting experience for taller users of cutting board 24. At least one more advantage is that items may be stored beneath cutting board 24, thereby opening space on counter surface 26 for other items. At least one more advantage is because cutting board 24 is elevated, the transfer of food upon cutting board 24 onto a container is facilitated as normally this transfer is accomplished by lifting cutting board 24 off of counter surface 26 and above a container to receive the food.

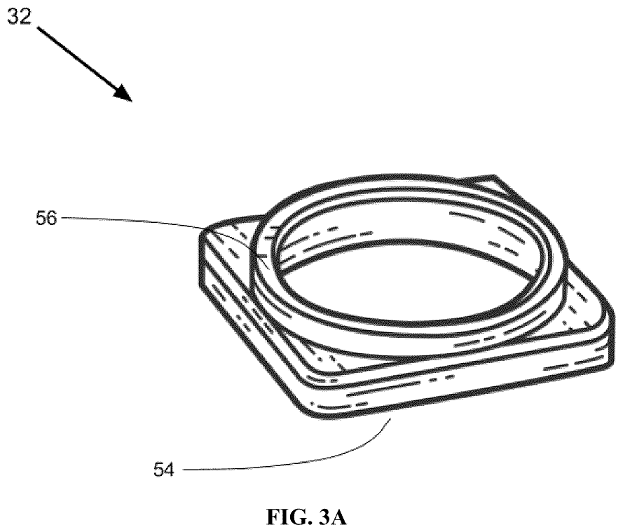

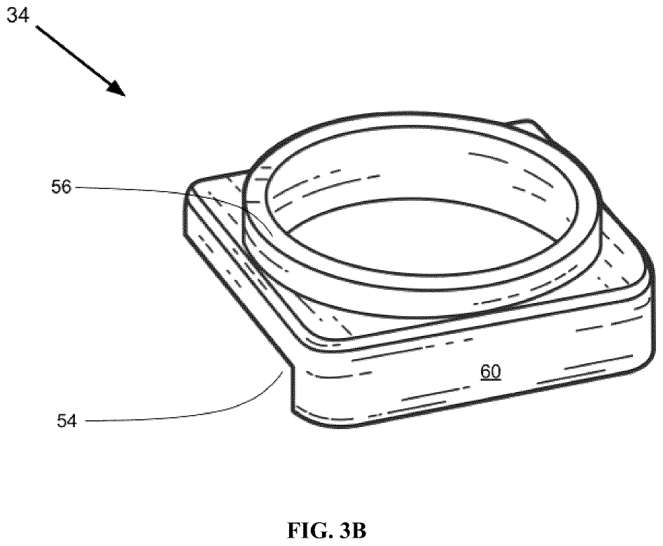

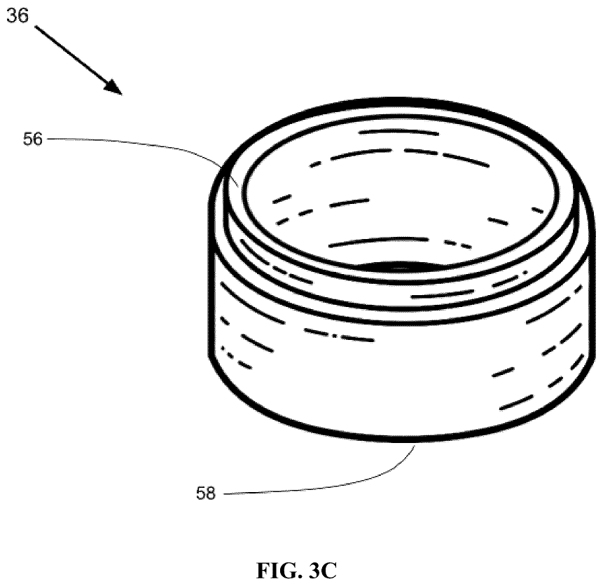

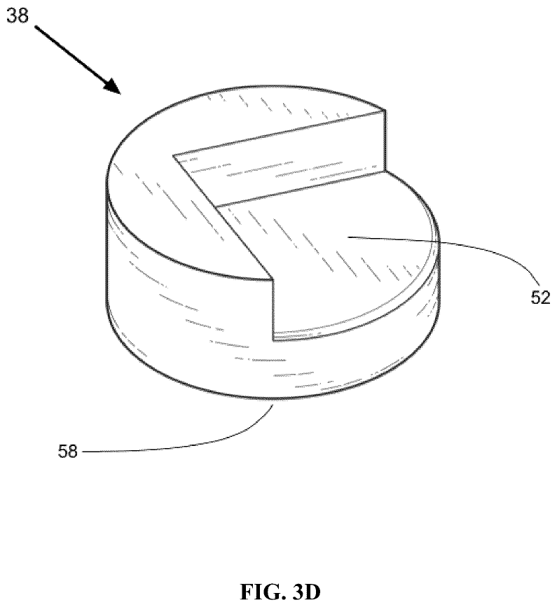

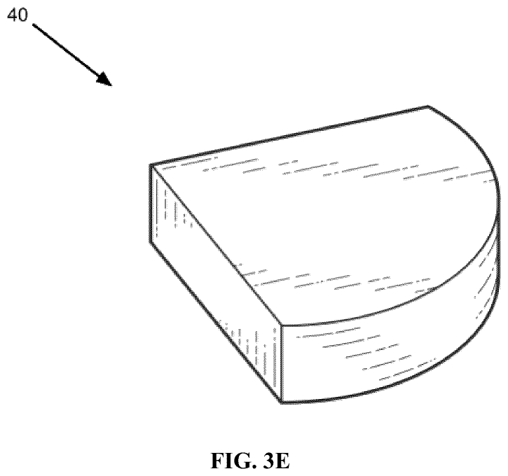

FIGS. 3A through 3E show an isometric view of each piece that makes up pillar 22 ranging from the lowest piece to the uppermost piece.

FIG. 3A shows an isometric view of flat base piece 32. Here, it is seen that flat base piece 32 is generally rectangular, having a certain height, width, and length. A non-skid surface may be attached to bottom 54 to discourage lateral movement of flat base piece 32 along counter surface 26. The top surface of flat base piece 32 contains male coupler 56 to allow flat base piece 32 to mate with female coupler 58 of either stacking piece 36 or top piece 38. The center portion of flat base piece 32's rectangle may be solid or, as shown in FIG. 3A, hollowed out.

Similar to flat base piece 32, shown in FIG. 3A, is edge base piece 34. FIG. 313 shows an isometric view of edge base piece 34. Here, it is seen that edge base piece 34 is generally rectangular, having a certain height, width, and length. A non-skid surface may be attached to bottom 54 to discourage lateral movement of edge base piece 34 along counter surface 26, The top surface of edge base piece 34 contains male coupler 56 to allow edge base piece 34 to mate with female coupler 58 of either stacking piece 36 or top piece 38. The center portion of edge base piece 34's rectangle may be solid or, as shown in FIG. 3B, hollowed out, Differentiating edge base piece 34 from flat base piece 32 is edge molding 60. As edge base piece 34 is designed to be positioned proximate to the edge of counter surface 26, edge molding 60 allows edge base piece 34 to “wrap around” the edge of counter surface 26 and thus provide a more secure positioning of edge base piece 34 as to counter surface 26.

In FIG. 3C, the present disclosure shows stacking piece 36. It may be seen from inspection of FIG. 3C that stacking piece 36 is generally cylindrical with a certain diameter and length so as to mate with any of flat base piece 32, edge base piece 34, other stacking piece 36s, or top piece 38. Additionally, stacking piece 36 may be solid or, as shown in FIG. 3C, hollow. Stacking piece 36's female coupler 58 is designed to form a friction fit with male coupler 56 of either flat base piece 32, edge base piece 34, or other stacking piece 36.

In FIG. 3D, an isometric view of top piece 38 is shown. Here it is seen that top piece 38 is generally cylindrical with a certain diameter and length with at least one end closed. Top piece 38 is so sized as to mate with any of flat base piece 32, edge base piece 34, or stacking piece 36. Additionally, top piece 38 may be solid or hollow. Top piece 38's female coupler 58 is designed to form a friction fit with male coupler 56 of either flat base piece 32, edge base piece 34, or stacking piece 36.

In FIG. 3E, an isometric view of corner cover 40 is shown. For those situations where cutting board 24 lacks rectangular corners or if the user of the elevated cutting board assembly of the present disclosure wishes to support cutting board 24 at some position other than its four corners, corner cover 40 may be used to occupy the space provided by recess 52 found on top piece 38. Corner cover 40 has a lower and an upper side. The upper side of corner cover 40 comes into contact with the lower side of cutting board 24. The upper side of corner cover 40 may comprise a non-skid surface to discourage the lateral movement of cutting board 24 as to corner cover 40,

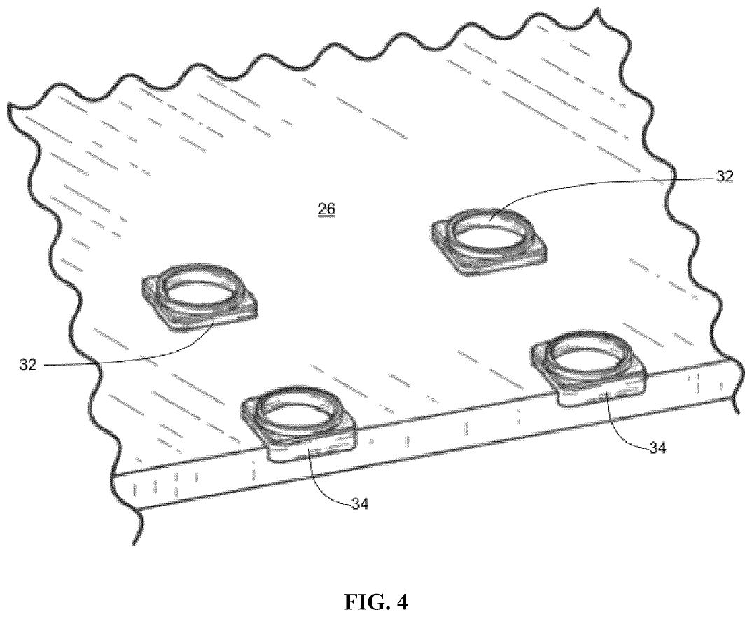

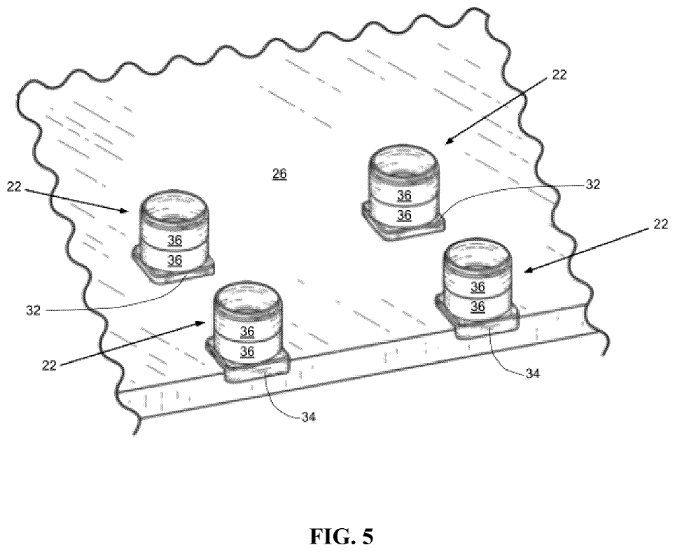

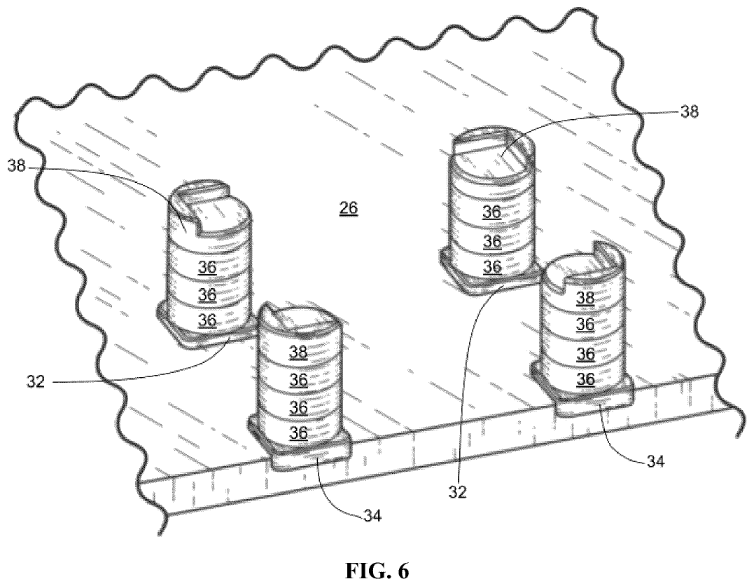

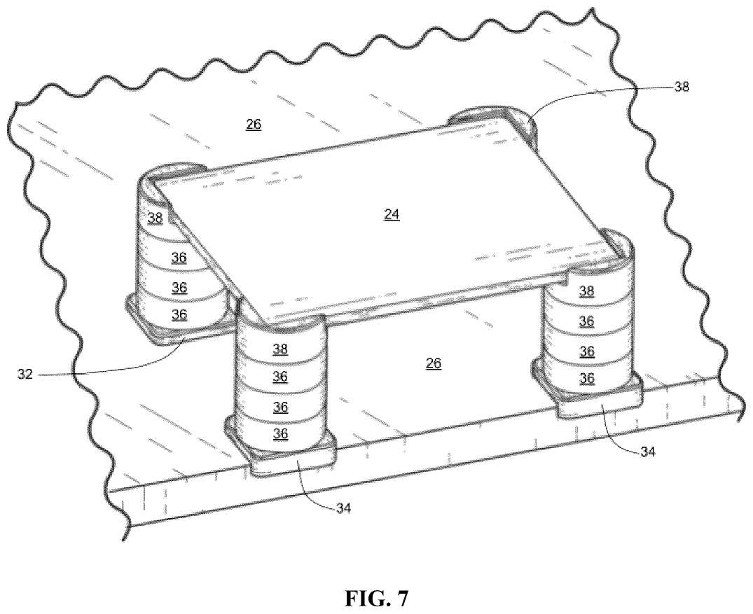

FIGS. 4 through 7 demonstrate how the elevated cutting board assembly of the present disclosure is assembled, in particular first embodiment 10. The process starts with the user selecting a flat surface where cutting board 24 is to be stationed. If cutting board 24 is to be stationed next to the edge of counter surface 26, then assembly of pillar 22 may be started as shown in FIG. 4 with two edge base piece 34 proximate to the edge of counter surface 26 and two flat base piece 32 an appropriate distance away from the edge of counter surface 26 to accommodate the depth of cutting board 24. If the user chooses to place cutting board 24 away from the edge of counter surface 26, then four flat base piece 32 will be used, each appropriately spaced apart to accommodate cutting board 24. The user will then determine how high cutting board 24 is to be raised from counter surface 26 and how many stacking piece 36 are to be used to raise cutting board 24 to that desired height. It may be possible that the user will only want to slightly raise cutting board 24 above counter surface 26. In such cases, it is possible that stacking piece 36 will not be used and top piece 38 will be fitted directly onto flat base piece 32 or edge base piece 34 so that the height of cutting board 24 will be the combined heights of top piece 38 and flat base piece 32 or edge base piece 34, However, it is common for one or more stacking piece 36 to be used in assembling pillar 22. In FIG. 5, the partially assembled pillar 22 are shown with either flat base piece 32 or edge base piece 34 as their base and two stacking piece 36 upon each of flat base piece 32 or edge base piece 34. Continuing on to FIG. 6, pillar 22 are shown in their assembled configuration for first embodiment 10, Each pillar 22 having a flat base piece 32 or edge base piece 34 as its base, three stacking piece 36, and a top piece 38. At this point, each pillar 22 is configured to receive a respective corner of cutting board 24 as shown in FIG. 7.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed and that that scope shall not be restricted, except in the light of the appended claims and their equivalents.

1. An adjustable cutting board apparatus comprising:
a cutting board that is generally planar, having a top surface and a bottom surface and to be used on a kitchen countertop; and
multiple pieces that may be releasably stacked together to form a pillar where each pillar supports said cutting board.

2. The adjustable cutting board of claim 1, where the number of said pillars is four.

3. The adjustable cutting board of claim 1, where a subset of said pieces are base pieces and configured to form the base of said pillar and engage the top surface of said countertop.

4. The base pieces of claim 3, where the bottom of said base piece comprises a non-skid surface.

5. The adjustable cutting board of claim 1, where a subset of said pieces are top pieces and configured to form the top of said pillar and engage the bottom surface of said cutting board.

6. The top pieces of claim 5, where the top of said top piece comprises a non-skid surface.

7. The adjustable cutting board of claim 1, where a subset of said pieces are stacking pieces and configured to form said pillar from said base piece to said top piece.

8. The adjustable cutting board of claim 1, where said pieces are releasably attached to one another by friction fit, twist and lock, or magnetic means.

9. The adjustable cutting board of claim 7, wherein the number of said stacking pieces used to form said pillar ranges from zero to four.
